(19) United States
(12) Patent Application Publication
(10) Pub. No.: US 2006/0005174 A1
(43) Pub. Date: Jan. 5, 2006

(54) Defining hierarchical structures with markup languages and reflection

(75) Inventors: Barry Alan Feigenbaum, Austin, TX (US); Michael A. Squillace, Austin, TX (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/882,630

(22) Filed: Jul. 1, 2004

(51) Int. Cl. G06F 9/45

(52) U.S. Cl. 717/143

(57) ABSTRACT

A method, a computer program, and an apparatus are provided for building a hierarchical data tree. Typically, hierarchical trees are utilized in building Graphic User Interfaces. However, there are a variety of other uses. During the process of building, a rendering engine is employed to develop the tree, but some objects, attributes, or tags may not be identifiable to the rendering engine. In such cases, a reflection engine can be employed to identify the unidentifiable operational elements. The combination of a rendering engine with a reflection engine allows for increased flexibility in designing a hierarchical tree without the rigors of handwriting a large number of lines of code.

### CROSS-REFERENCED APPLICATIONS

This application relates to co-pending U.S. patent application entitled “Method and Apparatus to Support Multiple Hierarchal Architectures” (Docket No. AUS920040546US1), filed on ______.

### FIELD OF THE INVENTION

The present invention relates generally to hierarchical structures, and more particularly, to methodologies for building hierarchical structures, such as graphic user interfaces (GUIs).

### DESCRIPTION OF THE RELATED ART

In the software industry, the use of GUIs for applications has been increasing. Specifically, GUIs are utilized because of their particular user-friendliness and because of increasing usage of computer networks, such as the Internet. Creation of the GUIs, though, can be complicated task. The creation of GUIs can be further complicated by desired characteristics, such as portability.

Conventionally, three methods for producing GUIs: hard coding, GUI building, and document based construction. Each of the three methods poses both specific drawbacks and advantages. Hard coding is the actual writing of the code by hand. A programmer would be responsible for drafting each line of code. As a result, hard coding can be labor intensive. However, hard coding provides a relatively easy avenue of changing the GUI, and the GUI can remain unchanged between platforms, assuming there is a portable GUI tool kit.

The use of GUI builders, on the other hand, provides a different subset of advantages and drawbacks. A GUI builder is relatively easy to use because the builders are typically drag-and-drop tools. A designer would not be required to have a substantial knowledge base of computer programming that would include both knowledge of nomenclature and knowledge of syntax. Instead, GUI builders are designed for usage by the broadest possible audience. However, GUI builders do not necessarily allow for ease of change, but in many cases, require a complete redesign. Additionally, GUI builders do not necessarily produce an interface that is identical across many platforms. A GUI can look completely different on two different platforms.

As a result of characteristics of hard coding and GUI building, document-based construction has become a popular basis for GUI designing and usage. Document-based constructions use a declarative textual form to describe the GUI. With document-based constructions, a designer would write a document that would be interpreted by a browser or application that would paint the GUI. Examples of these document-based constructions are the Hyper-Text Markup Language (HTML) and the Extendable Markup Language (XML) applications. The utilization of a document-based construction may allow user portability across a variety of platforms, but requires a designer to have some knowledge of syntax and nomenclature associated with the construction.

With the usage of a Markup Language (ML) to generate a document-based construction, there is typically a requirement of having a set of predetermined tags that define GUI elements. The tags typically refer to either behaviors or objects. For example, “FPAME” can be predefined as a tag for GUI element of a frame for a window. Likewise, “BUTTON” can also be used as a predefined tag for a button element in a frame. These tags are known to an engine, such as a browser, that interprets and paints the GUI. To make any additions or changes to the ML, code changes are generally necessary to the processor program, which can extend to a vast number of computers. Additionally, development of explicit processor functions per element type can be expensive and time consuming, considering that applications often have hundreds of types.

There are existing engines for rendering MLs, such as XML, however, that attempt to increase usage by having vast numbers of predefined tags for elements. For example, the Microsoft Corporation is developing a system known as “Avalon” that is going to be released with the “Longhorn” version of Windows®, available from Microsoft Corporation, One Microsoft Way, Redmond, Wash., 98052-6399. In the Avalon system, a vast number of tag definitions exist for elements.

It is true that increasing the number of predefined tags in for an engine will produce increased flexibility. However, there are drawbacks to having the vast number of predefined tags. For example, many, many lines of code are required to implement support for these tags. As a result of frequently having tens of thousands of lines of code, run-times and memory usage will increase. In fact, a user would be required to pre-load such an engine onto a system. There would be virtually no way to effectively download the engine at a desired usage time.

Therefore, there is a need for an ML engine for building and rendering GUIs that addresses at least some of the problems associated with conventional engines.

### SUMMARY OF THE INVENTION

The present invention provides a method, an apparatus and a computer program for building a hierarchal data tree from a data document. To build the data tree, the data document is parsed for at least one operational element. Once the operation element has been found, a determination is then made as to if the at least one operational element is identified. In some cases, the operation is identifiable, a reflection is then performed to identify one operational element.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a flow chart depicting a building process that employs reflection;

FIG. 2 is a block diagram depicting example of XML generated windows;

FIG. 3 is a flow chart depicting a reflective technique;

FIG. 4 is a flow chart depicting an example of a reflective technique using name reconstruction; and

FIG. 5 is a computer system for employing the hierarchical structure building process.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

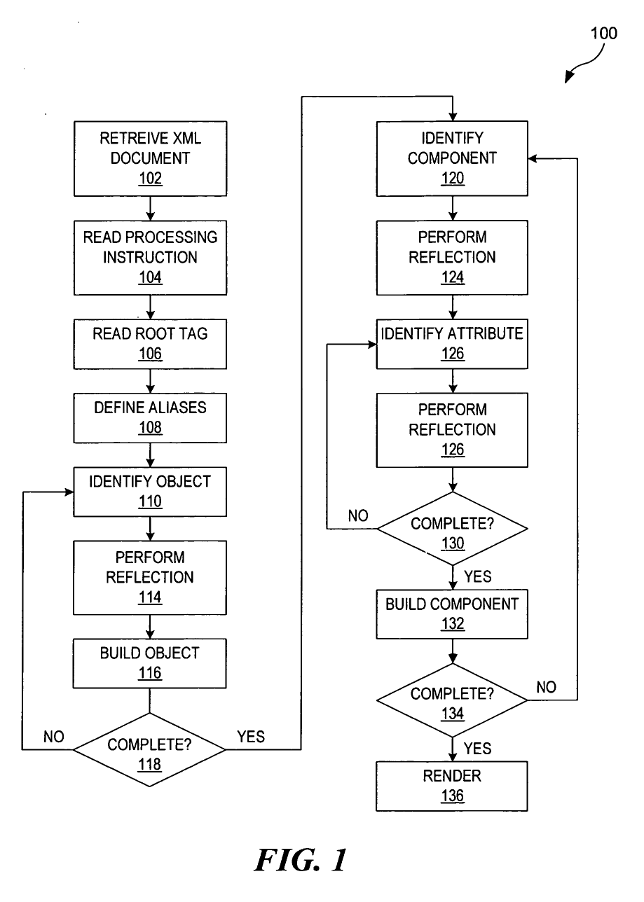

Referring to FIG. 1 of the drawings, the reference numeral 100 generally designates a process for building a hierarchical structure that employs reflection. The process 100, though, is typically utilized in building GUIs, which is the example used herein. The process can be utilized to build any number of hierarchical structures, such as database construction, or perform a variety of other tasks, such as verification. Specifically, the process 100 in constructing a GUI does not have extensive requirements for the XML or ML code. There is not a requirement for defining tags that represent GUI elements or actions on those elements, which constitute the vast bulk of element types in conventional ML based solutions. Inquiries can instead be made to determine the tag definitions.

In step 102, a XML document that defines a GUI's layout is retrieved. The XML document can be retrieved from a variety of sources including, but not limited to a disk file or across a network connection. An engine can then be employed to build a hierarchy. Some examples of engines are a reflection engine for processing XML documents and a rendering engine that draws a GUI that are both intended for Java® Swing, available from Sun Microsystems, Inc., 901 San Antonio Road, Palo Alto, Calif., 94303. Moreover, example of XML code for a GUI that employs Java® Swing is as follows:

```
<?xml version=“1.0”?>
<gui scriptlang=“jython”>
  <aliases>
    <alias
      name=“BorderLayout”
      value=“java.awt.BorderLayout”
    />
    <alias
      name=“accessibleName”
      value=“!qetAccessibleContext!setAccessibleName”
    />
    <alias
      name=“accessibleDesc”
      value=“!getAccessibleContext!setAccessibleDescription”
    />
  </aliases>
  <objects>
    <Dimension id=“screenDim”>300, 150</Dimension>
    <Color id=“bkgdColor”>224, 224, 255</Color>
  </objects>
  <components xmlns:rgb=“com.ibm.wac.rgb”>
    <Frame rgb:id=“mainFrame”
      size=“@screenDim”
      title=“RGB -- Sample 1”
      background=“@bkgdColor”
    >
      <getContentPane>
        <Panel rgb:id=“infoPanel” rgb:constraints=“NORTH”
          layout=“BorderLayout”
        >
          <Box rgb:constraints=“NORTH”>
            swing.BoxLayout.X_AXIS
            <horizontalGlue/>
            <Label rgb:id=“nameLabel”
              text=“Name:”
              labelFor=“@nameField”
              horizontalAlignment=“RIGHT”
            />
            <horizontalStrut width=“4”/>
            <TextField rgb:id=“nameField”
              columns=“20”>
              <accessibleName name=“name input field”/>
              <accessibleDesc
                desc=“Enter your full name”/>
            </TextField>
            <horizontalStrut width=“8”/>
            <Label rgb:id=“emailLabel”
              text=“Email:”
              labelFor=“@emailField”
              horizontalAlignment=“RIGHT”
            />
            <horizontalStrut width=“4”/>
            <TextField rgb:id=“emailField”
              columns=“20”>
              <accessibleName name=‘email input
field’/>
              <accessibleDesc
                desc=‘Enter your email address’/>
            </TextField>
            <horizontalGlue/>
          </Box>
          <Box rgb:constraints=“SOUTH”>
            swing.BoxLayout.X_AXIS
            <horizontalGlue/>
            <Button rgb:id=“clearButton” text=“Clear”>
              <mnemonic>
                awt.event.KeyEvent.VK_R
              </mnemonic>
              <addActionListener>
                nameField.text = “”
                emailField.text = “”
              </addActionListener>
            </Button>
            <horizontalStrut width=“6”/>
            <Button rgb:id=“exitButton” text=“Exit”>
              <mnemonic>
                awt.event.KeyEvent.VK_X
              </mnemonic>
              <addActionListener>
                confirm = \
swing.JOptionPane.showConfirmDialog(
                  mainFrame,
                  “Confirm Exit”,
                  “Confirm Exit Dialog”,
                  swing.JOptionPane.YES_NO_OPTION
                  )
                if confirm
==swing.JOptionPane.YES_OPTION:
                  lang.System.exit(0)
              </addActionListener>
            </Button>
            <horizontalGlue/>
          </Box>
        </Panel>
      </getContentPane>
    </Frame>
  </components>
</gui>
```

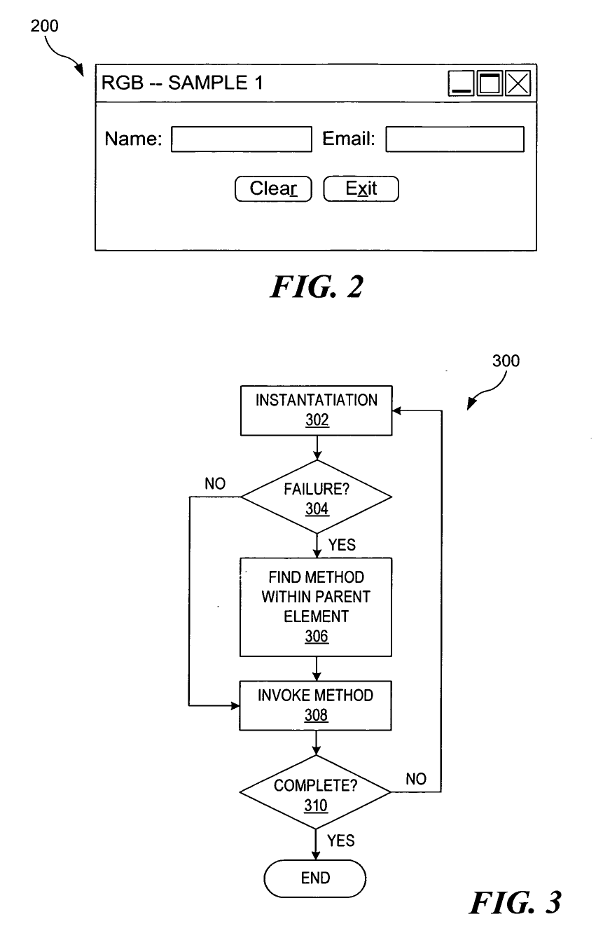

The example XML code then can create the window 200 of FIG. 2.

Once the XML code has been retrieved, the XML is parsed. There is first an examination of the code for specific identifiers (not shown). With the XML code in step 104, however, a process instruction that is defined by the following is read:
<?xml version=“1.0”?>
   The processing instruction identifies the code as an XML document.

Upon returning the processing instruction, further definitions can then be made. A root tag is read in step 106 that identifies the hierarchical structure. With the XML code, the root tag identifies the root as a GUI, which is defined by the following:

```
<gui scriptlang=“jython”>
<objects>
    <Dimension id=“screenDim”>300, 150</Dimension>
    <Color id=“bkgdColor”>224, 224, 255</Color>
</objects>
```

Also, when defining an object, however, it is possible to provide arguments within the element's text content, as shown, or as child elements.

A reflection Application Programming Interface (API) can then reflectively define an object in step 114. Typically, analysis is performed based on structure of the arguments and names. For example, a dimension object for the XML code can be defined as follows:

```
<Dimension rgb:id=“screenDim”>
    <x>300</x>
    <y>150</y>
</Dimension>
```

Accordingly, the reflection API will call the java.awt.Dimension constructor because there are two initial values as arguments. However, the dimension object can be alternatively defined as follow:

<Dimension rgb:id=“screenDim”>
<Point>300, 150</Point>
</Dimension>

The reflection API will then call the java.awt.Point constructor because of the construction of the dimension object.

Once reflectively resolved, the constructed object can then be built in step 116. The construction builds a data tree for future usage, such as rendering a GUI. Then a determination is made as to whether another object is to be defined and built in step 118. If there is another object that requires building, then the process begins again in step 110. However, if all objects are built then, the components can be built.

In step 120, a component is identified. A component is typically an item that includes, but not limited to, event handlers and windows. For example, the XML code defines “Frame” as component, which is defined as follows:

```
<Frame rgb:id=“mainFrame”
    size=“@screenDim”
    title=“RGB -- Sample 1”
    background=“@bkgdColor”
>
```

Within each component, there can be a set of attributes that are interpreted as properties of the component. The reflective API is again employed to define the component in step 124. In the XML code, the reflective API would invoke javax.swing.JFrame.

Once the component has been identified, the respective attributes are identified in step 126. The attributes are interpreted as properties of the component. For example, under “Frame,” the attributes are listed as “size,” “title,” and “background.” For each of the respective attributes, reflection can be performed in step 126. For example, the reflective API would invoke setSize for “size.” A determination would then be made as to whether all attributes have been defined in step 130. If all attributes have not been defined, then the process begins again by identifying another attribute in step 126. If all attributes had been defined, then the component is built in step 132.

Once the component has been built, then another determination is made. In step 134, a determination is made as to whether all components have been built. If all components have been built, then the data tree is complete and can be rendered in step 136. However, if all of the components have not been built, then another component is identified in step 120, beginning the process over.

The data trees take a variety of forms. However, a hierarchical tree of Java® Swing components that directly reflects the structure of the XML document above can be built as follows:

```
0: javax.swing.JFrame[mainFrame,(0,0),300x150]
    1: javax.swing.JPanel[null.contentPane,(4,30),292x116]
        2: javax.swing.JPanel[infoPanel,(4,30),292x46]
            3: javax.swing.Box[<none>,(4,30),292x20]
                4: javax.swing.Box$Filler[<none>,(4,40),0x0]
                4: javax.swing.JLabel[nameLabel,(4,32),36x16]
                4: javax.swing.Box$Filler[<none>,(40,30),4x20]
                4: javax.swing.JTextField[nameField,(44,30),103x20]
                4: javax.swing.Box$Filler[<none>,(147,30),8x20]
                4: javax.swing.JLabel[emailLabel,(155,32),34x16]
                4: javax.swing.Box$Filler[<none>,(189,30),4x20]
                4: javax.swing.JTextField[emailField,(193,30),103x20]
                4: javax.swing.Box$Filler[<none>,(296,40),0x0]
            3: javax.swing.Box[<none>,(4,50),292x26]
                4: javax.swing.Box$Filler[<none>,(4,63),83x0]
                4: javax.swing.JButton[clearButton,(87,50),64x26]
                4: javax.swing.Box$Filler[<none>,(151,50),6x26]
                4: javax.swing.JButton[exitButton,(157,50),55x26]
                4: javax.swing.Box$Filler[<none>,(212,63),83x0]
```

It can be noted that the named components correspond to the named components (from the rgb:id attribute) in the XML document. Each element is also followed by its screen location and screen size. Also the steps used to create this hierarchy had no specific knowledge of the element and/or attribute names that could be encountered, yet each was processed based on information proved reflexively from the Java Swing® GUI components themselves.

The process of reflection, though, is an involved process, requiring a number of steps. Referring to FIG. 3 of the drawings the reference numeral 300 generally designates a reflective process. Typically, the process 300 further details the reflective processes 114, 124, and 126 of FIG. 1.

In step 302, an element is instantiated. During instantiation, companion methods are employed. A method is sough to implement a defined object. An example from the XML code is as follows:
<getContentPane>
. . .
<getContentPane/>

The parent of this object, which is the JFrame object, invokes the getContentPane ( . . . ) method. However, a determination is made during the process as to whether there has been a failure in finding a method in step 304. If a method, such as the getContentPane ( . . . ), is found, then the method is invoked in step 308.

If there is a failure, then another method is employed in step 306. A variety of searching methodologies can be employed to find specifically required methods. The names can be varied. The arguments can be examined, and the desired results can be examined. However, there are a multitude of methodologies that can be employed. Then, once the method has been discovered, the method can be invoked in step 308. A determination can then be made in step 310 as to whether the process 300 has completed. If the process 300 has not completed, then it begins again in step 302.

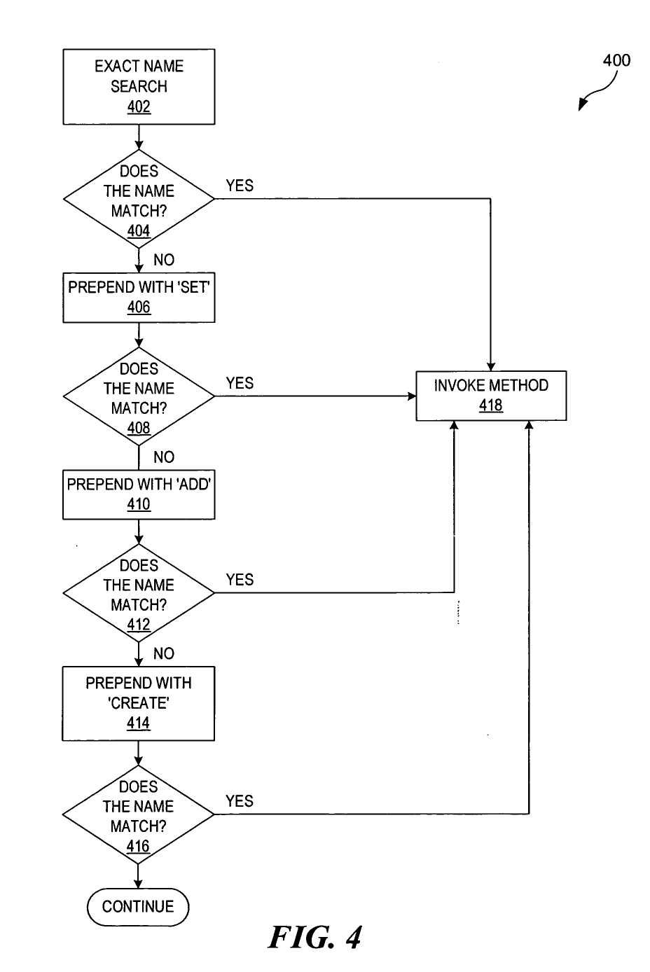

An example of the searching methodology that is employed with the XML code is the modification of the name. Referring to FIG. 4 of the drawings, the reference numeral 400 generally designates the name search process.

Once instantiation, such as the step of instantiation 302, has begun, a method with the same name can be searched in step 402. A determination can then be made in step 404 as to whether there is a matching name. If there is a matching name, then the method with the name can be invoked in step 418. As noted above, the method entitled “getContentPane ( . . . )” can be employed without modification.

However, if the exact name does not match, then the name is modified. The name is first prepended with “set” in step 406. A determination can then be made in step 408 as to whether there is a matching name. If there is a matching name, then the method with the name can be invoked in step 418. For example, assume that some XML code is written as follows:

```
<TextField ...>
    <getAccessibleContext>
        <AccessibleName name=”nameField”/>
    </getAccessibleContext>
    :
</TextField>
```

“AccessibleName” is not recognizable. However, if prepended with the term “set,” the resultant “setAccessibleName” is a recognizable method that would allow invocation.

If the name prepended with “set” does not match, then the name is again modified. The name is prepended with “add” in step 410. A determination can then be made in step 412 as to whether there is a matching name. If there is a matching name, then the method with the name can be invoked in step 418.

However, if the name prepended with “add” does not match, then the name is again modified. The name is prepended with “create” in step 414. A determination can then be made in step 416 as to whether there is a matching name. If there is a matching name, the method with the name can then be invoked in step 418. Additionally, the particular pattern of alternate names is not the only one possible. Alternate patterns, based on the particular problems, are common. However, there are a variety of patterns that can be employed.

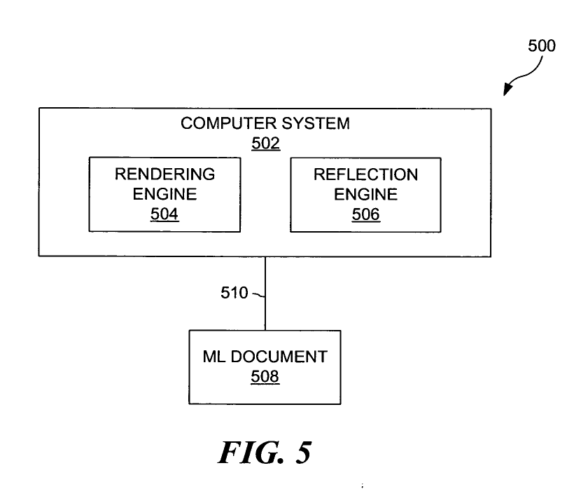

However, for all of these techniques to be implemented, a computer system is employed to build the hierarchical structure. Referring to FIG. 5 of the drawings, the reference numeral 500 depicts a computer system that employs the hierarchical structure building process. The computer system for building 500 comprises a computer system 502 and an ML document 508.

To function, the computer system 502 performs operations data from the ML document 508. The ML document 508 is communicated to the computer system 502 through a first communication channel 510. Upon reception of the ML document 508, the rendering engine 504 and the reflection engine 506 build a hierarchical structure based on data contained within the ML document 508. The rendering engine 504 and the reflection engine 506, in combination, utilize a reflective technique to build the hierarchical structure. Also, there are a variety of engine types, such as Java®, and a variety of reflective techniques, such as name reconstruction, that can be employed to build the hierarchical structure.

As a result, it is clear that the MLs, such as XML, can be extremely compact. There is not a requirement that all of the components be predefined. An engine, such as Java®, is responsible for determining the definitions for components, as needed. Also, because a vast number of component definitions can be eliminated, a very complicated GUI can be effectively created through rapid downloads and without a requirement of extensive storage. Additionally, runtimes may be effectively decreased.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for building a hierarchal data tree from a data document, comprising:
parsing the data document for at least one operational element;
determining if the at least one operational element is identified; and
if the at least one operational element is not identified, then performing reflection to identify the at least one operational element.

2. The method of claim 1, wherein the method further comprises:
collecting a plurality of identified operational elements; and
building a tree based on the plurality of identified operational elements.

3. The method of claim 1, wherein the step of parsing further comprises paring an Extended Markup Language (XML) document to for at least one operational element.

4. The method of claim 1, wherein the step of parsing further comprises paring an Extended Markup Language (XML) document to for at least one operational element selected from a group consisting of an object, component, and attribute.

5. The method of claim 1, wherein the method of reflecting further comprises performing name reconstruction for a title of the at least one operational element.

6. The method of claim 5, wherein the step of performing name reconstruction further comprises:
prepending the title with “set” to provide a prepended title; and
determining if the prepended title is identified.

7. The method of claim 5, wherein the step of performing name reconstruction further comprises:
prepending the title with “add” to provide a prepended title; and
determining if the prepended title is identified.

8. The method of claim 5, wherein the step of performing name reconstruction further comprises:
prepending the title with “create” to provide a prepended title; and
determining if the prepended title is identified.

9. A computer program product for building a hierarchal data tree from a data document, the computer program product having a medium with a computer program embodied thereon, the computer program comprising:
code for parsing the data document for at least one operational element;
code for determining if the at least one operational element is identified; and
if the at least one operational element is not identified, then code for performing reflection to identify the at least one operational element.

10. The computer program product of claim 9, wherein the computer program product further comprises building:
code for collecting a plurality of identified operational elements; and
code for building a tree based on the plurality of identified operational elements.

11. The computer program product of claim 9, wherein the code for parsing further comprises code for paring an Extended Markup Language (XML) document to for at least one operational element.

12. The computer program product of claim 9, wherein the code for parsing further comprises code for paring an Extended Markup Language (XML) document to for at least one operational element selected from a group consisting of an object, component, and attribute.

13. The computer program product of claim 9, wherein the computer program product of reflecting further comprises code for performing name reconstruction for a title of the at least one operational element.

14. The computer program product of claim 13, wherein the code for performing name reconstruction further comprises:
code for prepending the title with “set” to provide a prepended title; and
code for determining if the prepended title is identified.

15. The computer program product of claim 13, wherein the code for performing name reconstruction further comprises:
code for prepending the title with “add” to provide a prepended title; and
code for determining if the prepended title is identified.

16. The computer program product of claim 13, wherein the code for performing name reconstruction further comprises:
code for prepending the title with “create” to provide a prepended title; and
code for determining if the prepended title is identified.

17. An apparatus for building a hierarchal data tree from a data document with a plurality of operational elements, comprising:
a rendering engine that is at least configured to build the hierarchical data tree and that is at least configured to identify at least some of plurality of operational elements; and
a reflection engine that is at least configured to identify operational elements that the rendering engine is not able to identify.

18. The apparatus of claim 17, wherein the rendering engine is a JAVA® Swing rendering engine.

19. The apparatus of claim 17, wherein the reflection engine at least has the ability to query a platform for an identity based on characteristics of the operational elements that the rendering engine is not able to identify.

20. The apparatus of claim 17, wherein the reflection engine is at least configured to perform name reconstruction to identify the operational elements that the rendering engine is not able to identify.
